(19) United States
(12) Patent Application Publication
(10) Pub. No.: US 2016/0288315 A1
(43) Pub. Date: Oct. 6, 2016

(54) Length Marking Device

(71) Applicant: Steven Choate, Auberry, CA (US)

(72) Inventor: Steven Choate, Auberry, CA (US)

(21) Appl. No.: 15/090,395

(22) Filed: Apr. 4, 2016

Related U.S. Application Data
(60) Provisional application No. 62/142,527, filed on Apr. 3, 2015.

(51) Int. Cl. B25H 7/04; G01B 3/30

(52) U.S. Cl. CPC B25H 7/045; G01B 3/303

(57) ABSTRACT

A length marking device is provided that is used to mark measured distances along a work piece using a handheld tool that is struck on its ends to physically mark the work piece before cutting the same. The device comprises an elongated member having a first end, a second end, and a length. The first end comprises a strike plate that is designed to be struck by a hammer tool. Below the strike plate is a blade, which is pressed into the work piece upon being struck by the hammer. Along the second end of the device is a pointer, which extends substantially perpendicularly from the lower side of the elongated member. The pointer can be used to offset a previous mark, or can similarly be used to mark the work piece by striking the top side of the same. The pointer is optionally slidable along the member length.

### CROSS REFERENCE TO RELATED APPLICATION

This application claims the benefit of U.S. Provisional Application No. 62/142,527 filed on Apr. 3, 2015, entitled “Firewood Length Marker.” The above identified patent application is herein incorporated by reference in its entirety to provide continuity of disclosure.

### BACKGROUND OF THE INVENTION

### Field of the Invention

The present invention relates to tools and devices for measuring and marking. More specifically, the present invention relates to a combined measuring and marking device for work pieces, whereby the work piece can be measured and physically marked using a singular tool. In particular, a firewood work piece can be efficiently marked along its length prior to cutting the same into individual lengths.

Preparing equal lengths of firewood and other work pieces is best accomplished using a measuring tool. Measuring the cut length is more accurate than “eyeing-up” the length of the work piece to be cut. For firewood in particular, uniform lengths are preferred to ensure consistent burn time, and to ensure proper fitment into a fireplace or carrier. Uneven lengths are not desirable. While tape measures and other traditional measuring devices are useful, a need exists for swiftly and efficiently marking a work piece using a combined measuring and marking device. The present invention provides a measuring device that allows a user to physically mark a work piece, thereby ensuring measure lengths can be cut from an elongated work piece without switching between a marker and a measuring tool.

The tool of the present invention is a measuring tool and work piece marking tool, whereby the work piece is physically marked along its length to indicate cut locations therealong. The tool comprises an elongated member that can be physically grasped by hand. The first end of the device includes a downward-facing blade and a strike plate thereover. The opposite end of the device comprises a pointer element. The pointer element is either statically or slidably affixed along the length of the elongated member. Together, the pointer element and the downward-facing blade allow the user to make measured marks along the length of the work piece via physical indentations or impressions thereinto. The strike plate is adapted to be struck by a hammer or similar impact tool, forcing the blade into the work piece. The pointer tool is used to offset the blade from a given location or a previous mark. Optionally, the pointer element may also be strikable to mark the work piece using both ends of the device.

### SUMMARY OF THE INVENTION

The following summary is intended solely for the benefit of the reader and is not intended to be limiting in any way. The present invention provides a new length marking device that can be utilized for providing convenience for the user when marking measured lengths along a work piece using a strikeable tool.

It is therefore an object of the present invention to provide a new and improved length marking device that has all of the advantages of the prior art and none of the disadvantages.

It is another object of the present invention to provide a length marking device that combines the functions of measuring and marking a work piece into a single tool.

Another object of the present invention is to provide a length marking device having an elongated graspable member having a first end, a second end, and a length. The elongated member further comprises an upper side and a lower side, whereby the elongated member can be gripped in one hand to mark a work piece, while a striking tool can be grasped in a second hand to strike the device and thus mark the work piece.

Another object of the present invention is to provide a length marking device, whereby the first end of the elongated member comprises a strike plate disposed along the upper side thereof. The strike plate is adapted to be struck by a hammer or similar striking implement.

Another object of the present invention is to provide a length marking device whereby the strike plate comprises a substantially planar surface with a wider width relative to the width of the elongated member, and wherein the strike plate further comprises a hardened upper surface that is adapted to be receive blows from a hammer tool.

Another object of the present invention is to provide a length marking device whereby the first end further comprising a blade below the strike plate, the blade having a cutting edge disposed along the lower side thereof for marking the work piece when pressed thereinto.

Another object of the present invention is to provide a length marking device that comprises a pointer disposed along the length of the elongated member, whereby the pointer comprises a pointer body extending substantially perpendicularly from the lower side of the elongated member.

Another object of the present invention is to provide a length marking device whereby the pointer body and the blade have a lower extent that is substantially in plane with one another such that the elongated member is substantially parallel to a work piece surface when the lower extents of the pointer body and the blade are in contact with the work piece surface.

Another object of the present invention is to provide a length marking device whereby the pointer is slidably disposed along the length of the elongated member to adjust a distance between the pointer and the blade.

Another object of the present invention is to provide a length marking device whereby the slidable pointer further comprises a locking fastener to secure the slidable pointer along the length of the elongated member.

Another object of the present invention is to provide a length marking device whereby the slidable pointer further comprises a prismatic joint that facilitates sliding of the slidable pointer along the length of the elongated member.

Another object of the present invention is to provide a length marking device in which the prismatic joint further comprises a collar that secures around the elongated member and is affixed to the pointer body.

Another object of the present invention is to provide a length marking device whereby the distance between pointer body and the blade comprises a desired marking length. The user can make markings in a work piece by striking the strike plate while holding the elongated member, whereby the pointer is disposed at a desired location and the blade marks a length extending from the pointer location along the work piece. Optionally, the pointer may also be struck to make indentations in the work piece indicating the marking length thereon.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the length marking device of the present invention.

FIG. 2 shows a perspective view of another embodiment of the length marking device of the present invention.

FIG. 3 shows a perspective view the underside of the length marking device along the first end, whereby the blade and underside of the strike plate is visible.

FIG. 4 shows a perspective view the first end of the length marking device, whereby upper surface of the strike plate is visible.

FIG. 5 shows a view of the length marking device of the present invention in a working state, whereby a length of wood is being measured and marked using the tool and a striking implement.

### DETAILED DESCRIPTION OF THE INVENTION

Reference is made herein to the attached drawings. Like reference numerals are used throughout the drawings to depict like or similar elements of the length marking device of the present invention. For the purposes of presenting a brief and clear description of the present invention, the preferred embodiment will be discussed as used for making measured markings along a work piece using a combined measuring and marking tool. The figures are intended for representative purposes only and should not be considered to be limiting in any respect.

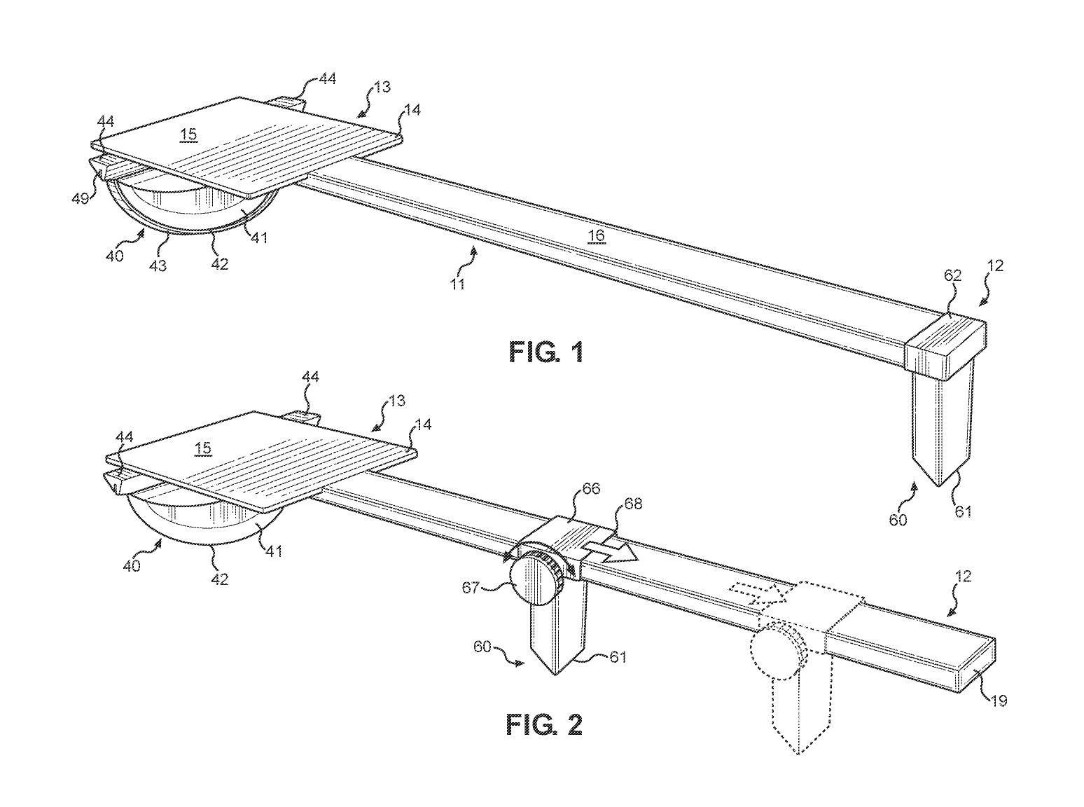

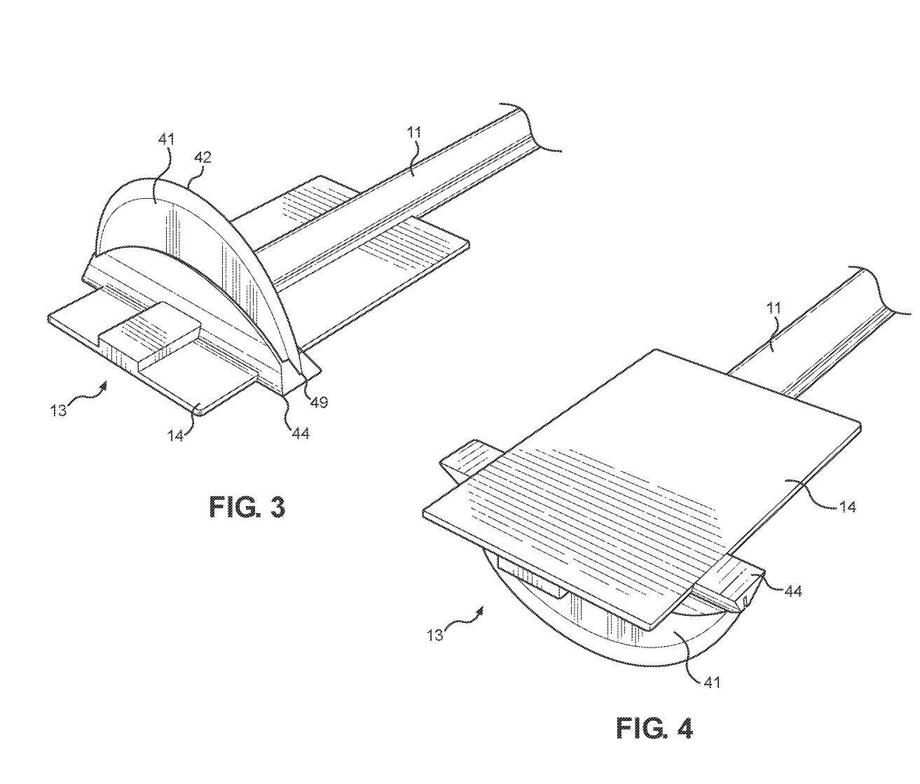

Referring now to FIGS. 1 through 4, there are shown views of the length marking device of the present invention. The length marking device is one that provides a user with a combined measuring and marking tool. The user grasps the device along its length and uses the ends of the device to mark a desired length along a work piece. One end is used to mark the work piece, while the other remains stationary at a datum point along the work piece length. Optionally, both ends of the device are capable of marking the work piece. The tool is ideal for marking equal length cuts of wood when cutting logs. However, this is one use that is contemplated, and is not considered limiting on the utility and usefulness of the device. The device is capable of making measured length markings along any work piece that will receive an impression or mark when struck by the blade of the present invention.

The length marking device of the present invention comprises an elongated member 11 having a length, a first end 13, and a second end 12. The elongated member 11 is adapted to be gripped by one hand while holding a striking implement with a second hand. The elongated member has a thickness, an upper surface 16, and a lower side. The first end 13 of the elongated member 11 further comprises a strike plate 14 and a blade member 40. The strike plate 14 is one that is adapted to be struck by a hammer or similar striking tool, while the blade member 40 is driven into the work piece by the energy of the striking tool impact on the strike plate 14.

The strike plate 14 of the device comprise a substantially planar surface 15, whereby the surface 15 is adapted to be struck by the striking tool. The planar surface 15 may comprise a wider width than that of the elongated member 11, thereby providing an increased area to strike the first end 13. The blade member 40 comprises a blade 41 with a sharpened lower edge 42. The blade 41 extends downwardly from the strike plate 13 and along the lower side of the elongated member 11. The blade 41 is situated such that it extends substantially perpendicularly to the elongated member length, and the lower extent of the blade member 41 comprises a blade edge 42 that is driven into the work piece by the impact of the striking tool.

The blade 41 is preferably secured with a blade holder 44, which extends laterally outward from the elongated member 11 and supports the upper end of the blade 41. The blade holder 41 clamps the upper end of the blade 41 within an elongated slot 49, retaining the upper end of the blade 41 against the first end 13 of the elongated member and statically below the strike plate 13. The blade 41 may or may not be removable from the blade holder 44 for replacement, depending on the design of the tool.

The shape of the blade 41 may take on several forms. It is not desired to limit the exact design and shape of the blade or the blade holder therefor. Rather, it is desired to disclose a blade 41 having a sharpened lower extent 42 and an upper end that is held along the first end 13 of the elongated member. In on embodiment, and as provided in the drawing views, the blade 41 comprises a rounded blade shape with an elongated edge around the lower periphery of the rounded blade. Optionally provided over the blade edge 42 is a removable sheath 43, which covers the sharpened edge of the blade 41 during nonuse to prevent injury, dulling of the blade, or unwanted contact with nearby items.

Along the second end 12 of the elongated member 11 is a pointer device 60. The pointer device 60 is one that is adapted to set a datum point or reference point along a work piece, wherefrom the measurement is made. The pointer device 60 includes a pointer body extending substantially perpendicularly from the lower side of the elongated member 11. The pointer body has a lower extent 61 that is preferably pointed or narrowed to a tip or edge. This allows the pointer to be pressed into a work piece and reduce movement while handling both measuring device and a striking implement. The lower extent 61 of pointer body and the lower extent 42 of blade 41 are preferably substantially in plane with one another such that the elongated member 11 is substantially parallel to a planar work piece surface when the lower extents 42, 61 of the pointer 60 and the blade 41 are in contact with the work piece surface. In other words, the extent to which the pointer 60 and the blade 41 extend from the lower side of the elongated member 11 is preferably equal, such that the member 11 is level when placed against a level work piece.

The pointer 60 comprises one of a static element along the elongated member 11, or a slidable element. FIG. 1 illustrates the static embodiment, whereby the pointer 60 is statically disposed along the length of the elongated member 11. The exact location may vary. FIG. 2 shows the sliding embodiment of the pointer 60. The sliding embodiment of the pointer 60 allows the pointer 60 to slide along the length of the elongated member 11 for changing the offset between the blade member 40 and the pointer 60. This allows for different lengths to be chosen.

In one embodiment, the slidable pointer 60 comprises a prismatic joint connection 66 with the elongated member 11 that facilitates sliding of the slidable pointer 60 along the length of the elongated member 11. The prismatic joint 66 may further comprises a collar or sleeve that receives the end 19 of the elongated member within its hollow interior 68 and secures around the outer periphery of the elongated member. Alternate configurations are contemplated, including other sliding joints along different surfaces of the elongated member. The elongated member 11 itself may comprises different cross sectional shapes, thereby necessitating different slidable connections between the pointer 60 and the elongated member 11. For instance, the pointer 60 may further comprise a tongue disposed within a channel along the length of the elongated member 11. It is not desired to limit the sliding joint to one embodiment, but rather to disclose a pointer that is slidably connected to the elongated member such that the distance between the pointer 60 and the blade member 40 can be changed by the user.

In yet another embodiment of the slidable pointer, the slidable pointer further comprises a locking fastener 67 to secure the slidable pointer along the length of the elongated member 11. The locking faster 67 prevents sliding motion when engaged, and allows sliding motion of the pointer 60 when disengaged. The locking fastener 67 may comprise a threaded set screw with a knob for manual operation.

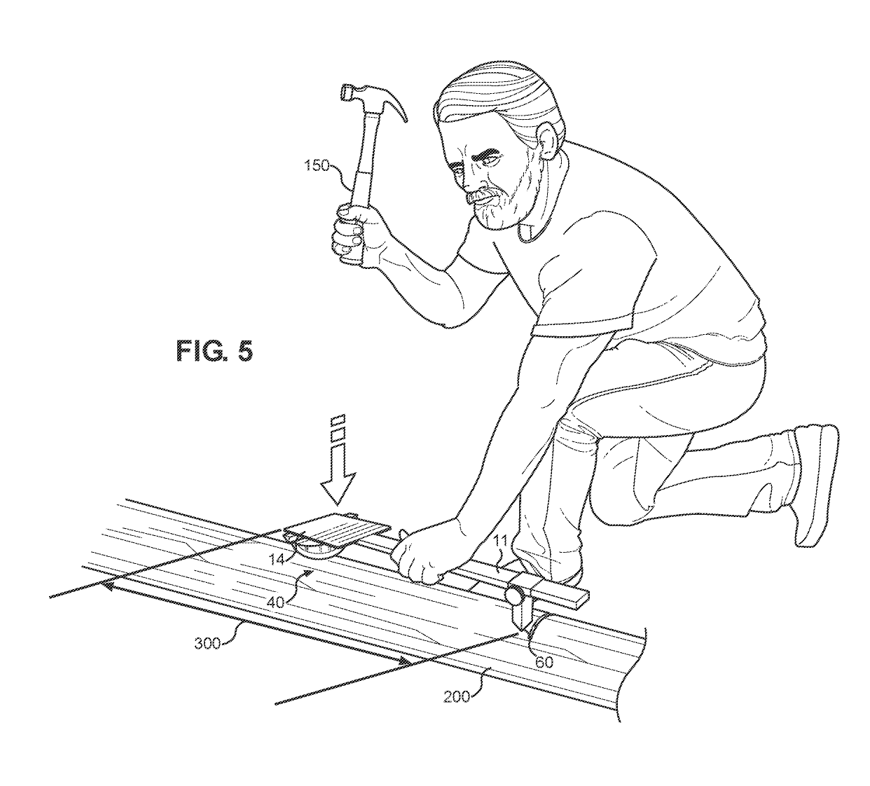

In operation and as shown in FIG. 5, the pointer 60 is set against the work piece 200 in a location from which the measurement will commence. The user grasps the elongated member 11 in one hand, pressing the pointer into the work piece at a desired location (i.e. at a reference location, datum location, or previous marking). The pointer 60 has been set along the length of the elongated member 11 to provide a desired offset between the blade member 40 and the pointer, thus providing a desired measurement length 300. The user supports the elongated member 11 in one hand while grasping a striking implement 150 (e.g. a hammer or mallet) in the other. The user strikes the strike plate 14 with the striking implement 150, whereby the blade is pressed into the work piece outer surface, marking the same. The upper surface of the strike plate 14 preferably comprises a hardened upper surface, and the thickness is designed to receive striking blows from a striking tool. Optionally, the user can strike the upper surface of elongated member 11 above the pointer 60, or the upper surface of the pointer sleeve, to cause the edge of the pointer 60 to mark the work piece. However, this may or may not be desirable depending on the design of the tool. In addition, it is contemplated that measurement indicia may be provided along the upper surface of the elongated member, whereby the measurement indicia indicate the offset distance 300 between the blade member 40 and the pointer 60.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A length marking device, comprising:
an elongated member having a first end, a second end, and a length;
the elongated member further comprising an upper side and a lower side;
the first end of the elongated member further comprises a strike plate disposed along the upper side thereof;
the strike plate comprising a substantially planar surface;
the first end further comprising a blade having a cutting edge disposed along the lower side thereof;
a pointer disposed along the length of the elongated member, whereby the pointer comprises a pointer body extending substantially perpendicularly from the lower side of the elongated member;
whereby the pointer body and the blade have a lower extent that is substantially in plane with one another such that the elongated member is substantially parallel to a planar work piece surface when the lower extents of the pointer body and the blade are in contact with the work piece surface.

2) The length marking device of claim 1, wherein:
the pointer is slidably disposed along the length of the elongated member to adjust a distance between the pointer and the blade.

3) The length marking device of claim 2, wherein:
the slidable pointer further comprises a locking fastener to secure the slidable pointer along the length of the elongated member.

4) The length marking device of claim 2, wherein:
the slidable pointer further comprises a prismatic joint that facilitates sliding of the slidable pointer along the length of the elongated member.

5) The length marking device of claim 4, wherein the prismatic joint further comprises a collar that secures around the elongated member. 6) The length marking device of claim 1, wherein:
a distance between pointer body and the blade comprises a marking length; and
whereby a user can make markings in a work piece by striking the strike plate, and optionally the pointer, to make indentations in the work piece indicating the marking length thereon.

7) The length marking device of claim 1, wherein the strike plate further comprises a wider width relative to a width of the elongated member.

8) The length marking device of claim 1, wherein the strike plate further comprises a hardened upper surface that is adapted to be receive blows from a hammer tool.
